(19) United States
(12) Patent Application Publication
(10) Pub. No.: US 2003/0055132 A1
(43) Pub. Date: Mar. 20, 2003

(54) Method of preparing a cohesive product from a low density feedstock

(76) Inventor: Michael Windsor Symons, Pretoria (ZA)

Correspondence Address: PILLSBURY WINTHROP, LLP, P.O. BOX 10500, MCLEAN, VA, 22102, US

(21) Appl. No.: 10/169,942

(22) PCT Filed: Dec. 28, 2000
(86) PCT No.: PCT/IB00/01970

(30) Foreign Application Priority Data
Feb. 10, 2000 (ZA) 20000631
Jul. 26, 2000 (ZA) 20003769

(51) Int. Cl. C08K 11/00; C08K 3/34

(52) U.S. Cl. 524/2; 524/16; 524/442

(57) ABSTRACT

A method of preparing a cohesive product having a density of from 250 kg/m³ to 900 kg/m³ from a low density feedstock, such as a milled thermoset resin foam, includes the steps of providing the feedstock in the form of substantially dry finely divided particles or fibres, mixing the feedstock with a suitable amount of a thermosetting resin in finely divided dry powder form and a suitable amount of a hydraulic binder in finely divided dry powder form, to give a dry starting material having a compression ratio of at least 2:1, and forming the starting material into a mat and pressing the mat at suitable conditions of temperature and pressure to compress the mat and to cause the thermosetting resin to set to form the cohesive product. Thereafter, there may be provided to the cohesive product water in an amount sufficient for the hydration of the hydraulic binder so that the hydraulic binder sets to form a finished product.

### BACKGROUND OF THE INVENTION

This invention relates to a method of preparing a cohesive product from a low density feedstock such as for example a milled thermoset resin foam, and to a process of preparing a finished product therefrom.

Many types of composite board products are known. For example, WO 98/37032 in the name of Windsor Technologies Limited teaches a method of preparing a cohesive product from a feedstock selected from a lignocellulosic material, exfoliated vermiculite, expanded perlite, and a mixture of two or three thereof, by providing the feedstock in the form of substantially dry finely divided fibres or particles, mixing the feedstock with a suitable amount of a thermosetting resin in finely divided dry powder form and a suitable amount of a hydraulic binder in finely divided dry powder form to give a dry starting material, and subjecting the dry starting material to suitable conditions of temperature and pressure to cause the thermosetting resin to set to form the cohesive product.

Thereafter there may be provided to the cohesive product, water in an amount sufficient for the hydration of the hydraulic binder so that the hydraulic binder sets to form the finished product, which may be used as a composite board.

There is however always a need to prepare new composite board products.

### SUMMARY OF THE INVENTION

According to a first aspect of the invention there is provided a method of preparing a cohesive product having a density of from 250 kg/m³ to 900 kg/m³ inclusive, from a low density feedstock, which method includes the steps of:

(1) providing the feedstock in the form of substantially dry finely divided particles or fibres;

(2) mixing the feedstock with:

(a) a suitable amount of a thermosetting resin in finely divided dry powder form, and

(b) a suitable amount of a hydraulic binder in finely divided dry powder form, to give a dry starting material having a compression ratio of at least 2:1; and

(3) forming the starting material into a mat and pressing the mat at suitable conditions of temperature and pressure to compress the mat and to cause the thermosetting resin to set to form the cohesive product.

By “compression ratio” there is meant the ratio of the volume of the mat before pressing to the volume of the cohesive product after pressing and setting of the thermosetting resin.

The dry starting material preferably has a compression ratio of at least 2,5:1, more preferably at least 3,5:1, and in certain circumstances at least 5:1.

The cohesive product preferably has a density of from 350 kg/m³ to 700 kg/m³ inclusive.

The low density feedstock is preferably selected from the group consisting of:

(a) a milled thermoset resin foam;

(b) a mixture of

(i) particles of a thermoplastic resin foam, and

(ii) another particulate material,

in a mass ratio of (i) to (ii) of 20:80 to 60:40, preferably 30:50 to 50:50;

(c) textile waste fibres with a melting point exceeding 180° C.; and

(d) ground cork particles;

any one of the feedstocks (a), (c) and (d) optionally being mixed with up to 75% by mass of the feedstock of exfoliated vermiculite particles or expanded perlite particles or a mixture thereof.

The feedstocks (a) to (d) ensure that the finished product not only has a low density but also possesses good machinability and nailability characteristics.

The thermosetting resin is preferably a novolac phenol formaldehyde resin which is used with a suitable catalyst.

The hydraulic binder is preferably selected from the group consisting of Portland cement, high alumina cement, gypsum cement, calcium sulphate hemihydrate in either the alpha or beta form, magnesium oxychloride, magnesium oxysulphate, a calcium sulphoaluminate cement, an alkali silicate, a pozzolan such as ground granulated blast furnace slag or fly ash, and a mixture of two or more thereof.

The mass ratio of the hydraulic binder to the feedstock is preferably from 1:2 to 20:1, i.e. an amount of 50% to 2 000% inclusive of the hydraulic binder by 100% by mass of the feedstock, more preferably in the mass ratio of 1:1 to 5:1.

The mass ratio of the thermosetting resin to the hydraulic binder is preferably from 2:100 to 25:100, i.e. the thermosetting resin is used in an amount of from 2% to 25% inclusive of the thermosetting resin by 100% by mass of the hydraulic binder.

In addition, the cohesive product may include other components such as for example reinforcing fibres and the like.

Preferably, in step (3), the mat is pressed at a temperature of from about 100° C. to 220° C. inclusive, at a press ire up to 20 kg/cm² to produce the cohesive product.

According to a second aspect of the invention there is provided a process of preparing a finished product from a cohesive product produced by the method described above, which process includes the step of:

(A) providing to the cohesive product, water in an amount sufficient for the hydration of the hydraulic binder so that the hydraulic binder sets to form the finished product.

According to a third aspect of the invention there is provided a cohesive product comprising a low density feedstock and a hydraulic binder all bound together with a thermosetting resin which is set, the cohesive product having a density of from 250 kg/m³ to 900 kg/m³ inclusive.

According to a fourth aspect of the invention there is provided a finished product comprising a low density feedstock and a hydraulic binder all bound together with a thermosetting resin which is set, the hydraulic binder having been hydrated and thus set, the finished product having a density of from 270 kg/m³ to 950 kg/m³ inclusive.

### DESCRIPTION OF EMBODIMENTS

The crux of the invention is that a feedstock consisting of lightweight or low density particles or fibres is introduced into a mixture of a hydraulic binder and a thermosetting resin, in finely divided dry particle or fibre form, in order to produce a dry starting material with a low bulk density and which has a compression ratio of at least 2:1. Using such a dry starting material, it is possible to form a cohesive product with a density of as low as 250 kg/m³, but which still has the required degree of cohesive strength before hydration.

The low density feedstock may be any suitable low density feedstock. When the feedstock is a milled thermoset resin foam or contains particles of a thermoplastic resin foam, the thermoset resin foam or the thermoplastic resin foam must have a bulk density lower than 100 g/l, preferably in the range of from 30 to 60 g/l inclusive.

For all other feedstocks, particularly those listed above, the feedstock must have a bulk density of lower than 250 g/l, preferably lower than 200 g/l.

The first example (a) is a milled thermoset resin foam such as for example a phenol formaldehyde resole resin foam. A second example of a milled thermoset resin foam is a closed cell rigid polyurethane foam such as that recovered as industrial waste from scrapped insulation and is thus widely available at low cost. The foam is a thermoset resin foam, i.e. the resin has already been set, and this is then milled to a suitable particle size. Foam rigidity is preferable for milling to small particle sizes. These particles generally have a density of from 30 kg/m³ to 60 kg m³ (or 30 g/l to 60 g/l).

The phenol formaldehyde resole foams and closed cell rigid polyurethane foams are preferred because of their ability to withstand temperatures exceeding 150° C. which temperature may be reached during the pressing of the dry starting material. These foams are ideal propagators of syntactic voids in the finished product, which thereby allows one to achieve sufficient reduction in the density of the finished product.

This feedstock also allows the finished product to be easily machined and nailed, imposes upon the finished product a high apparent porosity gives the finished product favourable resistance to freeze thaw cycles, lowers the cost of the finished product as a function of both density reduction and utilisation of waste product, improves thermal insulation, reduces the tendency to crack in fire, allows the finished product to be nailed or worked with conventional tools, and is not subject to degradation by the action of either fungi or insects, and in the case of the polyurethane foams, in particular, resistance to “water wicking” or capillary movement of water or water penetration is minimised.

Using these feedstocks it is possible to achieve a cohesive product with a density of from 250 kg/m³ to about 900 kg/m³. This is an advance over known cohesive products. Such products, after hydration, are suitable for use as building boards, or as the core for laminate flooring or the like.

The thermoset resin foam is preferably milled to produce finely divided particles with a particle size less than 0,75 mm in diameter, more preferably less than 0,4 mm in diameter. The particles preferably have a jagged configuration so as to minimised separation of the particles from the dry starting material before pressing.

The second example (b) is a mixture of particles of a (i) thermoplastic resin foam and (ii) another particulate material, in a mass ratio of (i) to (ii) of 20:80 to 60:40, preferably 30:50 to 50:50.

The particles of a thermoplastic resin foam are preferably particles of a polystyrene foam.

The particles are preferably produced by feeding the thermoplastic resin foam onto a moving abrasive belt, such as 36 grit sandpaper. The particles are abraded from the foam in a suitable particle size, which is dependent upon the grit of the sandpaper or abrasive projections on the belt. This method provides particles which are difficult or impossible to produce through techniques such as milling.

The second particulate material (ii) may be selected from the group consisting of exfoliated vermiculite particles; expanded perlite particles; ground or milled thermoset resin foam particles such as ground rigid polyurethane foam particles and ground closed cell phenol formaldehyde resole resin foam particles; ground cork particles; hollow glass balloons and other similar light weight particles.

The particles of a thermoplastic resin foam preferably have a particle size of less than 0,75 mm in diameter, more preferably less than 0,4 mm in diameter. The particles of another particulate material preferably have a similar particle size or a larger particle size, up to an upper limit of about 2 mm.

When a mixture of (i) particles of a thermoplastic resin foam and (ii) another particulate material, is used as the feedstock in the method described above, during processing in step (3) the thermoplastic resin foam tends to melt and to migrate to the surface of the cohesive product, to produce a hard water resistant skin.

The third example (c) is textile waste fibres with a melting point exceeding 180° C., i.e. cottons and polyesters. These fibres preferably have a length of up to 12 mm and an aspect ratio (ratio of length to diameter of 20:1. or greater.

The fourth example (d) is ground cork particles, which generally will have a density of about 170 g/l. Cork is a thin layer in the bark of all trees but is preferably derived from the cork oak Quercus Suber. The ground cork particles preferably have a particle size of less than 2 mm in diameter, more preferably less than 1 mm in diameter.

Any one of the feedstocks (a), (c) and (d) may optionally be mixed with up to 75% by mass of the feedstock of exfoliated vermiculite particles or expanded perlite particles or a mixture thereof. For example the low density feedstock may comprise 25% by mass of a milled thermoset resin foam and 75% by mass of exfoliated vermiculite particles.

The exfoliated vermiculite particles have a particle size of from less than 0.5 mm to 3 mm diameter inclusive.

The expanded perlite particles have a particle size of nil retained on a 45 micron screen up to a mean particle size of 550 micron.

The thermosetting resin is any resin in finely divided dry powder form which at elevated temperatures melts, flows and polymerises to bind the cohesive product.

The thermosetting resin is preferably a novolac phenol formaldehyde resin which is used with a suitable catalyst. Novolac phenol formaldehyde resins are resins in which the molar ratio of phenol to formaldehyde exceeds parity. An example of a suitable catalyst is hexamethylene tetramine. The properties of a typical novolac phenol formaldehyde resin are that it is a two stage resin with a hexamethylene tetramine content of between 6% and 14%, a hot plate gel time at 150° C. of between 40 and 120 seconds, with a flow in millimeters at 125° C. of between 30 mm and 75 mm, and with a particle size sieve analysis percentage retained on a 200 mesh screen of a maximum of 2%.

Another example of a suitable thermosetting resin of the phenolic type, which may be used on its own or as a blend with a conventional novolac phenol formaldehyde resin, is a chemically modified mimosa (wattle) product with some thermoplastic properties, used in finely divided dry powder form, and catalysed with hexamethylene tetramine or other formaldehyde donor in the range of from 8% t 10%. This resin has the following typical analysis:

Total volatiles 8%; moisture 4%, polyphenolic (flavonoid) content 67%; non-phenolic content 26%; water insolubles less than 0,5%, pH 6,5 to 7,5, gel time at 170° C. at 10% hexamethylene tetramine of 180 to 200 seconds; and a melt point (capillary) of between 110° C. and 120° C.

The thermosetting resin is preferably used in an amount of from 2% to 25% inclusive of the thermosetting resin by mass of the hydraulic binder, i.e. in a mass ratio of the thermosetting resin to the hydraulic binder of from 2:100 to 25:100.

The hydraulic binder is preferably chosen from the group comprising Portland cement, high alumina cement particularly where the finished product is for refractory application, gypsum cement, calcium sulphate hemihydrate either in the alpha or beta form, magnesium oxychloride, magnesium oxysulphate, a calcium sulphoaluminate cement, an alkali silicate such as sodium silicate, a pozzolan such as ground granulated blast furnace slag or fly ash, or a combination of any two or more thereof.

The hydraulic binder is preferably used in an amount of from 50% to 2 000% inclusive of the hydraulic binder by mass of the feedstock, i.e. a mass ratio of the hydraulic binder to the feedstock of from 1:2 to 20:1, preferably in a mass ratio of 1:1 to 5:1.

The hydraulic binder has a particle size of from 300 to 450 m²/kg inclusive.

Other components may also be added into the mixture. For example there may be included reinforcing fibres such as polyacrylonitriles, polyvinyl alcohols, polyesters, acrylics, polypropylenes, polyethylenes, milled fibreglass, chopped strand figreglass, ceramic fibres and mineral fibres. For example, when the hydraulic binder is a calcium aluminate cement extended with a milled thermoset foam, there may be added a ceramic fibre so that, during preparation of the finished product, the thermoset foam may be burnt out at temperatures in the range of 500° C. to 700° C. to produce a finished product which is refractory and which is reinforced with the ceramic fibre.

Preferably, any reinforcing fibres used have a length of from 1 mm to 12 mm, more preferably from 2 mm to 4 mm, with small diameters and high aspect ratios.

In step (2) of the method of the invention, the feedstock is mixed with the hydraulic binder and the thermosetting resin to give a dry starting material having a compression ratio of at least 2:1.

In step (3) of the method of the invention, the dry starting material is formed into a mat and pressed at suitable conditions of temperature and pressure to compress the mat and to cause the thermosetting resin to set to form the cohesive product. The pressing may, for example, be carried out between the platens of a press.

In step (3), suitable temperatures are from 100° C. to 220° C. inclusive, preferably from 150° C. to 190° C. inclusive, and suitable pressures are up to 20 kg/cm², preferably from 5 to 15 kg/cm² inclusive.

The result of the method of the invention is a cohesive product which may then be stored until needed.

The second aspect of the invention is a process for preparing a finished product from a cohesive product produced as described above, by providing to the cohesive product, water in an amount sufficient for the hydration of the hydraulic binder so that the hydraulic binder sets to form the finished product.

In step (A) of the process of the invention, in providing water to the cohesive product in a sufficient amount for complete hydration of the hydraulic binder, a partially hydrolised polyvinyl alcohol may be included at a level of from 1% to 5% by mass of the water, further to reinforce the cohesive product and to act as a scavenger for any small residue of free formaldehyde in the product by its conversion in forming a polyvinyl acetal resin. An example of a suitable polyvinyl alcohol is Mowiol 4/88 by Clariant.

The finished product has a low density of from 270 kg/m³ to 950 kg/m³ and is thus very useful as a building board or the like.

Processes for the introduction of the water into the cohesive product are described in WO 98/37032 which is incorporated herein by reference.

Examples of the invention will now be given.

### EXAMPLE 1

The following components are mixed together to form a dry starting material:

| | |
|---|---|
| Calcium sulphate beta-hemihydrate- | 63.5% |
| Finely divided particles of a phenol formaldehyde thermoset- | 30% |
| foam with a starting density in the range 10 kg/m³ to 35 kg/m³ | |
| A novolac phenol formaldehyde resin with 7% hexamethylene- | 6% |
| tetramine content | |
| 3 mm polyacrylonitrile fibres, 6 dtex- | 0.5% |
| 500 000 fibres/g | |

This dry composition is intimately mixed and is spread into a mat of approximately 45 mm in height, at a weight of 0,6 g/cm², on a caul plate. The dry mat is then pressed at a temperature of about 180° C. for three minutes at a pressure of 15 kg/cm² to form a cohesive product with a thickness of 10 mm and a final density of 600 kg/m³.

The cohesive product may then be hydrated with water to cause the hydraulic binder to set to form the finished product.

The finished product is a ceiling board which is smooth, easily painted, easily sawn or nailed, behaves well in fire, is thermally insulating, is cost effective and versatile.

### EXAMPLE 2

A starting material was formed from the following:

| | |
|---|---|
| Calcium sulphate beta hemihydrate | 63% |
| Novolac thermosetting resin Code 602 by Schenectady Corporation | 3% |
| Ground rigid polyurethane foam particles with a density of | 17% |
| 35 kg/m³ | |
| Abraded fine particles of polystyrene foam regrind | 17% |

The starting material as described above was formed into a mat and pressed at a temperature of about 200° C. to give a cohesive product with a hard water resistant skin, formed from the melting of the polystyrene foam particles, with some of the melted styrene migrating to the outer surfaces of the cohesive product. The core of the board comprised the residue of the polystyrene, giving auxiliary binding to the polyurethane foam particles and the calcium sulphate beta hemihydrate.

Thereafter, the board was post hydrated by water impregnation, in a pressure cylinder involving vacuum followed by pressure. Any excess water was removed by drying and there resulted a strong light weight building board that could be easily nailed, cut, worked, handled, and painted.

The board had a density of about 600 kg/m³.

### EXAMPLE 3

A starting material was formed from the following:

| | |
|---|---|
| Portland cement | 20% |
| Calcium sulphate beta hemihydrate | 20% |
| Micron grade exfoliated vermiculite | 42% |
| (particle size less than 1 mm diameter) | |
| Milled expanded polystyrene | 15% |
| Resin Code 602 by Schenectady Corporation | 3% |

The starting material as described above was formed into a mat and pressed at a temperature of about 200° C. to give a cohesive product. Thereafter the cohesive product was post hydrated by water impregnation to give a finished board with a density of about 750 kg/m³.

1. A method of preparing a cohesive product having a density of from 350 kg/m³ to 700 kg/m³ both inclusive from a low density feedstock including the steps of:
(1) providing the feedstock in the form of substantially dry finely divided particles or fibres, the feedstock being selected from the group consisting of:
(a) a milled thermoset resin foam;
(b) a mixture of
(i) particles of a thermoplastic resin foam, and
(ii) another particulate material,
in a mass ratio of (i) to (ii) of 20:80 to 60:40;
(c) textile waste fibres with a melting point exceeding 180° C.;
(d) ground cork particles;
any one of the feedstocks (a), (c) and (d) optionally being mixed with up to 75% by mass of the feedstock of exfoliated vermiculite particles or expanded perlite particles or a mixture thereof;
(2) mixing the feedstock with:
(a) a suitable amount of a thermosetting resin in finely divided dry powder form, and
(b) a suitable amount of a hydraulic binder in finely divided dry powder form,
to give a dry starting material wherein the mass ratio of the hydraulic binder to the feedstock is from 1:2 to 20:1, the mass ratio of the thermosetting resin to the hydraulic binder is from 2:100 to 25:100, and the dry starting material has a compression ratio of at least 2:1: and
(3) forming the starting material into a mat and pressing the mat at suitable conditions of temperature and pressure to compress the mat and to cause the thermosetting resin to set to form the cohesive product

2. A method according to claim 1 wherein the low density feedstock is a milled thermoset resin foam.

3. A method according to claim 1 wherein the low density feedstock is a mixture of:
(i) particles of a thermoplastic resin foam, and
(ii) another particulate material,
in a mass ratio of (i) to (ii) of 20:80 to 60:40.

4. A method according to any one of claims 1 to 3 wherein the thermosetting resin is a novolac phenol formaldehyde resin which is used with a catalyst.

5. A method according to any one of claims 1 to 4 wherein the hydraulic binder is selected from the group consisting of Portland cement, high alumina cement, gypsum cement, calcium sulphate hemihydrate in either the alpha or beta form, magnesium oxychloride, magnesium oxysulphate, a calcium sulphoaluminate cement, an alkali silicate, a pozzolan, and a mixture of two or more thereof.

6. A method according to any one of claims 1 to 5 wherein the mass ratio of the hydraulic binder to the feedstock is from 1:1 to 5:1.

7. A method according to any one of claims 1 to 6 wherein in step (3) the mat is pressed at a temperature of from 100° C. to 220° C. inclusive and at a pressure up to 20 kg/cm², to produce the cohesive product.

8. A process for preparing a finished product from a cohesive product produced by a method according to any one of claims 1 to 7, the process including the step of:
(A) providing to the cohesive product water in an amount sufficient for the hydration of the hydraulic binder so that the hydraulic binder sets to form the finished product.

9. A cohesive product comprising a low density feedstock selected from the group consisting of:
(a) a milled thermoset resin foam;
(b) a mixture of
(i) particles of a thermoplastic resin foam, and
(ii) another particulate material,
in a mass ratio of (i) to (ii) of 20:80 to 60:40;
(c) textile waste fibres with a melting point exceeding 180° C.;
(d) ground cork particles; and
any one of the feedstocks (a), (c) and (d) optionally being mixed with up to 75% by mass of the feedstock of exfoliated vermiculite particles or expanded perlite particles or a mixture thereof, and a hydraulic binder all bound together with a thermosetting resin which is set, wherein the mass ratio of the hydraulic binder to the feedstock is from 1.:2 to 20:1 and the mass ratio of the thermosetting resin to the hydraulic binder is from 2:100 to 25:100, the cohesive product having a density of from 350 kg/cm³ to 700 kg/cm³ both inclusive.

10. A cohesive product according to claim 9 wherein the thermosetting resin is a novolac phenol formaldehyde resin which is used with a catalyst.

11. A cohesive product according either of claims 9 or 10 wherein the hydraulic binder is selected from the group consisting of Portland cement, high alumina cement, gypsum cement, calcium sulphate hemihydrate in either the alpha or beta form, magnesium oxychloride, magnesium oxysulphate, a calcium sulphoaluminate cement, an alkali silicate, a pozzolan, and a mixture of two or more thereof.

12. A finished product comprising a low density feedstock selected from the group consisting of:
(a) a milled thermoset resin foam;
(b) a mixture of
(i) particles of a thermoplastic resin foam, and
(ii) another particulate material,
in a mass ratio of (i) to (ii) of 20:80 to 60:40;
(c) textile waste fibres with a melting point exceeding 180° C.;
(d) ground cork particles; and
any one of the feedstocks (a), (c) and (d) optionally being mixed with up to 75% by mass of the feedstock of exfoliated vermiculite particles or expanded perlite particles or a mixture thereof, and a hydraulic binder all bound together with a thermosetting resin which is set, the hydraulic binder having been hydrated and thus set, wherein the mass ratio of the hydraulic binder to the feedstock is from 12 to 20:1 and the mass ratio of the thermosetting resin to the hydraulic binder is from 2:100 to 25:100, the finished product having a density of from 270 kg/m³ to 950 kg/m³ both inclusive.

13. A finished product according to claim 12 wherein the thermosetting resin is a novolac phenol formaldehyde resin which is used with a catalyst.

14. A finished product according to either of claims 12 or 13 wherein the hydraulic binder is selected from the group consisting of Portland cement, high alumina cement, gypsum cement, calcium sulphate hemihydrate in either the alpha or beta form, magnesium oxychloride, magnesium oxysulphate, a calcium sulphoaluminate cement, an alkali silicate, a pozzolan, and a mixture of two or more thereof.
